(19) United States
(12) Patent Application Publication
(10) Pub. No.: US 2014/0133866 A1
(43) Pub. Date: May 15, 2014

(54) DRIVING DEVICE, OPTICAL EMITTER, AND OPERATION METHOD THEREOF

(71) Applicant: INDUSTRIAL TECHNOLOGY RESEARCH INSTITUTE, Hsinchu (TW)

(72) Inventors: Yu-Feng Liu, New Taipei (TW); Chien-Hung Yeh, Hsinchu (TW); Chi-Wai Chow, HONG KONG (CN)

(73) Assignee: INDUSTRIAL TECHNOLOGY RESEARCH INSTITUTE, Hsinchu (TW)

(21) Appl. No.: 13/730,304

(22) Filed: Dec. 28, 2012

(30) Foreign Application Priority Data
Nov. 14, 2012 (TW) 101142515

(51) Int. Cl. H05B 37/02

(52) U.S. Cl. CPC H05B 37/02
USPC 398/182; 315/250; 315/201; 315/185 R

(57) ABSTRACT

A driving device adapted to at least one light emitting diode, includes a clock recovery unit, a modulation unit, and a bias tee unit. The clock recovery unit receives a first alternating current signal, and generates a square wave signal according to the first alternating current signal. The modulation unit is coupled to the clock recovery unit, for receiving the square wave signal and a signal source, and for generating a message signal by using the square wave signal and the signal source. The bias tee signal is coupled to the modulation unit, for receiving a second alternating current signal and the message signal, and for outputting a driving signal to at least one light emitting diode by using the second alternating current signal and the message signal, in order to make at least one light emitting diode generate an optical signal.

### CROSS-REFERENCE TO RELATED APPLICATIONS

This non-provisional application claims priority under 35 U.S.C. §119(a) on Patent Application No(s). 101142515 filed in Taiwan, R.O.C. on Nov. 14, 2012, the entire contents of which are hereby incorporated by reference.

### TECHNICAL FIELD

The disclosure relates to a driving device, an optical emitter, and an operation method thereof.

### BACKGROUND

The light emitting diode (LED) has the advantages of fast responding speed, small volume, power saving, low pollution, high reliability, low cost, and long lifetime, etc.

Thus, the LED is applied to various technical fields, such as large billboards, traffic lights, cell phones, scanners, the light source of a facsimile machine, and illumination devices, etc. In addition, the LED is modulated by electrical signals, such as a proper bias voltage and the small signal modulation, for simultaneously performing the visible light communication (VLC) and the light emitting.

Nowadays, there are many documents and researches for providing a driving circuit which generates the driving signal by loading digital information into electrical power signal, and drives the LED according to the driving signal carrying digital information, to emit light, in order to transmit data through the VLC. Moreover, the driving circuit also uses the techniques of orthogonal frequency division multiplexing (OFDM) or discrete multi tone (DMT), for generating the modulation signals, in order to enhance the available bandwidth and the spectral efficiency of the VLC.

However, when applying signals to AC LEDs, the aforementioned driving method with on-off keying requires the high pass filter to cancel the effect of power signal, which corrupts the digital message signal because the spectral overlapping and the limited efficiency of available time for transmitting.

### SUMMARY

The disclosure relates to a driving device which is adapted to at least one light emitting diode (LED). The driving device includes a clock recovery unit, a modulation unit, and a bias tee unit. The clock recovery unit receives a first alternating current (AC) signal, and generates a square wave signal according to the first AC signal. The modulation unit is coupled to the clock recovery unit, receives the square wave signal and a signal source, and generates a message signal according to the square wave signal and the signal source. The bias tee unit is coupled to the modulation unit, receives a second AC signal and the message signal, and outputs a driving signal to at least one LED by using the second AC signal and the message signal, so as to make the at least one LED generate an optical signal.

The disclosure relates to an optical emitter including a first signal source generation unit, a first clock recovery unit, a first modulation unit, a first bias tee unit, and at least one LED. The first signal source generation unit generates a first signal source. The first clock recovery unit receives a first AC signal, and generates a first square wave signal according to the first AC signal. The first modulation unit is coupled to the first clock recovery unit, receives the first square wave signal and the first signal source, and generates a first message signal according to the first square wave signal and the first signal source. The first bias tee unit is coupled to the first modulation unit, receives a second AC signal and the first message signal, and generates a first driving signal according to the second AC signal and the first message signal. The at least one LED is coupled to the first bias tee unit, receives the first driving signal to generate a first optical signal.

The disclosure relates to an operation method of an optical emitter, and the method includes the following steps. A first signal source is provided. A first AC signal is received, and a first square wave signal is generated according to the first AC signal. A first message signal is generated according to the first square wave signal and the first signal source. A first driving signal is generated according to a second AC signal and the first message signal. A t least one LED is driven according to the first driving signal to generate a first optical signal.

### BRIEF DESCRIPTION OF THE DRAWINGS

The present disclosure will become more fully understood from the detailed description given herein below for illustration only, and thus does not limit the present disclosure, wherein:

FIG. 1 is a schematic diagram of an optical emitter according to a first embodiment of the disclosure;

FIG. 2 is a waveform diagram of a first alternating current signal and a first square wave signal according to the first embodiment of the disclosure;

FIG. 3 is a schematic diagram of a first driving signal and the clipped first driving signal according to the first embodiment of the disclosure;

FIG. 4 is a schematic diagram of an optical signal generated by a first light emitting diode module and measured by experiments, according to the first embodiment of the disclosure;

FIG. 5A is a schematic diagram of a signal waveform generated by a band pass filter receiving an optical signal generated by a first light emitting diode module according to the first embodiment of the disclosure;

FIG. 5B is a schematic diagram of the signal waveform in FIG. 5A which is enlarged partially;

FIG. 6 is a constellation diagram of a modulation signal generated by a low pass filter receiving the signal in FIG. 5A;

FIG. 7 is an eye diagram of the signals generated by the low pass filter receiving the signal in FIG. 5A;

FIG. 8 is a schematic diagram of an optical emitter according to a second embodiment of the disclosure;

FIG. 9 is a schematic diagram of an optical emitter according to a third embodiment of the disclosure;

FIG. 10 is a schematic diagram of an optical emitter according to a fourth embodiment of the disclosure;

FIG. 11 is a schematic diagram of an optical emitter according to a fifth embodiment of the disclosure;

FIG. 12 is a schematic diagram of a first driving signal, a clipped first driving signal, a second driving signal, a clipped second driving signal and a combination of the clipped first driving signal and the clipped second driving signal according to the fifth embodiment of the disclosure;

FIG. 13 is a simulation schematic diagram of the clipped first driving signal, the clipped second driving signal and the combination of the clipped first driving signal and the clipped second driving signal, which are measured by experiments, according to the fifth embodiment of the disclosure;

FIG. 14 is an eye diagram of signals generated by decoding a first optical signal and a second optical signal generated respectively by the first light emitting diode module and the second light emitting diode module in FIG. 11;

FIG. 15 is a schematic diagram of an optical emitter according to the sixth embodiment of the disclosure;

FIG. 16 is a flow chart of an operation method of an optical emitter according to an embodiment of the disclosure; and

FIG. 17 is a flow chart of an operation method of an optical emitter according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The embodiments described below use the same label for representing the same or similar components.

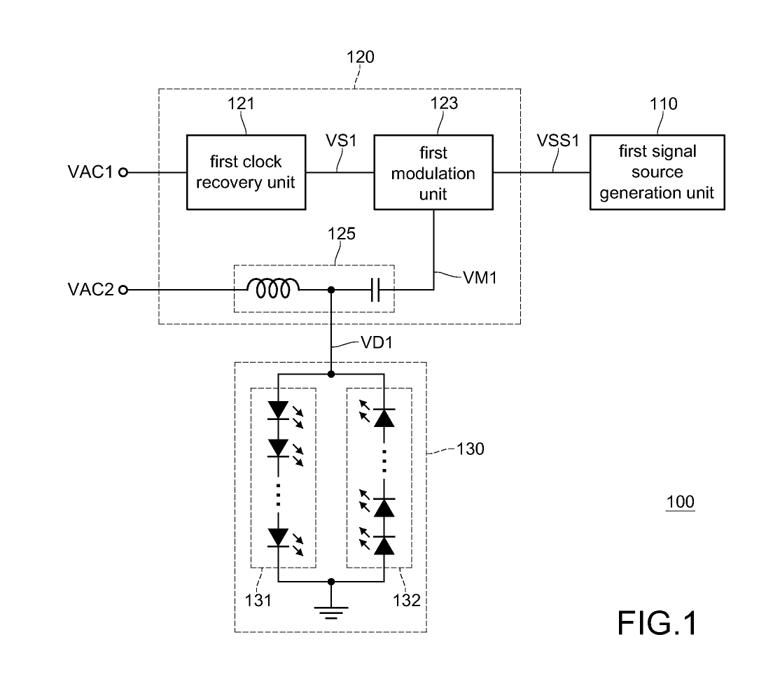

FIG. 1 is a schematic diagram of an optical emitter according to a first embodiment of the disclosure. The optical emitter 100 includes a first signal source generation unit 110, a driving device 120, and a first light emitting diode (LED) module 130.

The first signal source generation unit 110 generates a first signal source VSS1. The first signal source VSS1 is, for example, a binary sequence signal. The driving device 120 includes a first clock recovery unit 121, a first modulation unit 123, and a first bias tee unit 125.

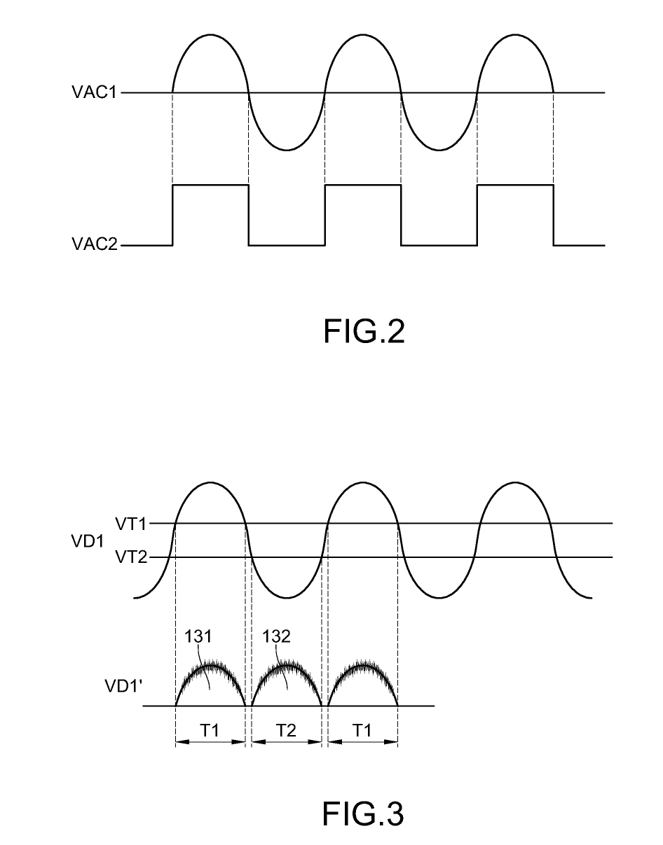

The first clock recovery unit 121 receives a first alternating current (AC) signal VAC1, and generates a first square wave signal VS1 according to the first AC signal VAC1. The duty cycle of the first square wave signal VS1 is, for example, 50%, and the frequency of the first square wave signal VS1 is locked at the frequency of the first AC signal VAC1, as shown in FIG. 2. That is, the first square wave signal VS1 and the first AC signal VAC1 are synchronous. In addition, the frequency of the first AC signal VAC1 is, for example, 60 Hz, 120 Hz, or 180 Hz, etc.

The first modulation unit 123 is coupled to the first clock recovery unit 121 and the first signal source generation unit 110. The first modulation unit 123 receives the first square wave signal VS1 and the first signal source VSS1, and generates a first message signal VM1 according to the first square wave signal VS1 and the first signal source VSS1. In this embodiment, the first modulation unit 123 is triggered by, for example, the rising edges of the first square wave signal VS1, to determine the timing of generating the first message signal VM1. The first modulation unit 123 can generate the waveform VM1 in different waveform formats. The first message signal VM1 signal has a short burst of waveform carrying the message from the first signal source VSS1, and the short burst is located according to the timing determined by the first square wave signal VS1.

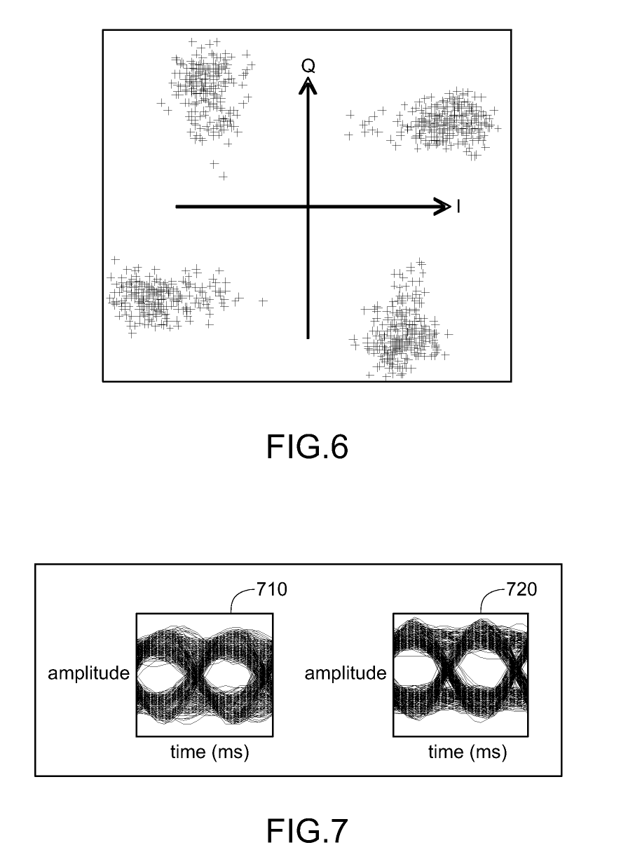

For example, a quadrature phase shift keying (QPSK) vector signal as shown in FIG. 6, which has a symbol rate of 200 Kbps and a carrier frequency of 400 KHz, which can be seen as a mix of an in-phase carrier and a quadrature-phase carrier and carry two channels of message as shown FIG. 7. Moreover, the modulation manner of the first modulation unit 123 is, for example, the on-off keying (00K) manner.

The first bias tee unit 125 is coupled to the first modulation unit 123. The first bias tee unit 125 receives a second AC signal VAC2 and the first message signal VM1, and generates a first driving signal VD1 according to the second AC signal VAC2 and the first message signal VM1. The first bias tee unit 125 combines the second AC signal VAC2 and the first message signal VM1, so that the first driving signal VD1 can provide the first message signal VM1 which includes transmitted data and the proper second AC signal VAC2. The first message signal VM1 can be any band-pass signal with a spectrum non-overlapping the spectrum of the second AC signal VAC2.

The first LED module 130 is coupled to the first bias tee unit 125. The first LED module 130 receives the first driving signal VD1 to generate a first optical signal. The first LED module 130 includes a plurality of first LEDs, for example, AC LEDs, which are connected in series (hereinafter called “a first LED series 131”), and a plurality of second LEDs, for example, AC LEDs, which are connected in series (hereinafter called “a second LED series 132”). The first LED series 131 is connected with the second LED series 132 in inverse parallel. The two ends of the first LED series 131 respectively receives the first driving signal VD1 and is grounded, and the two ends of the second LED series 132 respectively receives the first driving signal VD1 and is grounded. The polarity of the first driving signal VD1 required to turn on the first LED series 131 is reverse to the polarity of the first driving signal VD1 required to turn on the second LED series 132.

The optical emitter 100 in this embodiment generates the first driving signal VD1 by combining the second AC signal VAC2 and the first message signal VM1 via the first bias tee unit 125, so as to drive the first LED module 130. The driven first LED module 130 transmits data through the first message signal VM1, and works in a linear region through the second AC signal VAC2 which has a large bias voltage. Therefore, the optical emitter 100 can operate without an AC to DC converter, so as to reduce its cost, increase its efficiency, and avoid signal transmission distortions.

In this embodiment, the first AC signal VAC1 and the second AC signal VAC2 are, for example, the main power supply electricity of 100 V, and the first AC signal VAC1 and the second AC signal VAC2 have the same voltage level and signal waveform.

In addition, the LED has a turned-on threshold. When the first driving signal VD1 is provided to the first LED module 130, the voltage of the first driving signal VD1 is required to exceed the turned-on threshold of the first LED module 130, so that the first LED module 130 is turned on and emits light. Thus, the first driving signal VD1 is required to be clipped, and the first LED module 130 is driven by the clipped first driving signal VD1′ to generate the optical signal. The period of the clipped first driving signal VD1′ is, for example, a time slot.

FIG. 3 is a schematic diagram showing the first driving signal VD1 and the clipped first driving signal VD1′ according to the first embodiment of the disclosure. The label VT1 is the turned-on threshold of the first LED series 131, the label VT2 is the turned-on threshold of the second LED series 132, and the labels T1 and T2 are time slots.

In FIG. 3, the first LED series 131 and the second LED series 132 correspond to the time slots T1 and T2, so that the first LED module 130 is turned on and emits light in the time slots T1 and T2. In addition, it is required to providing the first message signal VM1 in the first driving signal VD1 in the time period of the time slots T1 and T2, so that the optical signal generated by the first LED module 130 may transmit data efficiently. Specifically, the first LED module 130 is required to work in the burst mode.

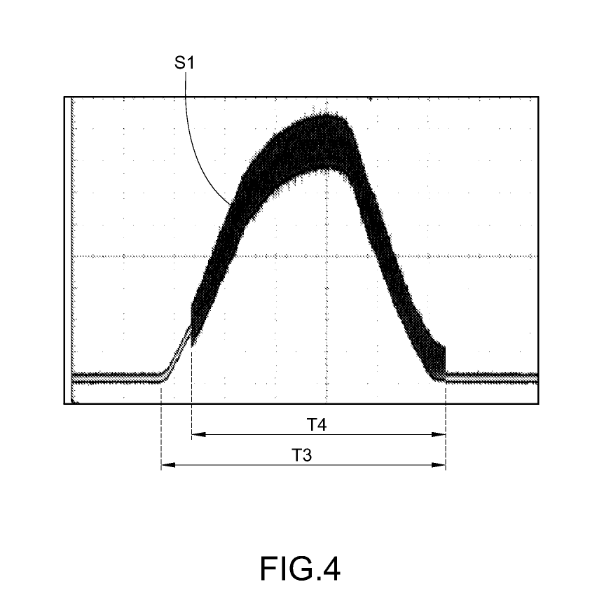

FIG. 4 shows the optical signals which are generated by the first LED module 130 and measured by experiments, according to the first embodiment of the disclosure. In the experiment environment as, for example, a free space, an oscilloscope having a receiver receives the optical signals generated by the first LED module 130, and the transmission distance between the oscilloscope and the first LED module 130 is 2 meters.

In FIG. 4, the curve S1 represents the demodulated waveform of the optical signals generated by the first LEDs. For example, the demodulated waveform of the optical signals corresponds to the clipped first driving signal VD1′. The label T3 is a time slot, and the label T4 is the time period of the first message signal VM1. In FIG. 4, the optical emitter 100 in this embodiment successfully transmits the first optical signal carrying the first message signal VM1 in the time period T4 which is in the time period of the time slot T3. In addition, the label T3 corresponds to the time slots T1 and T2 in FIG. 3 respectively.

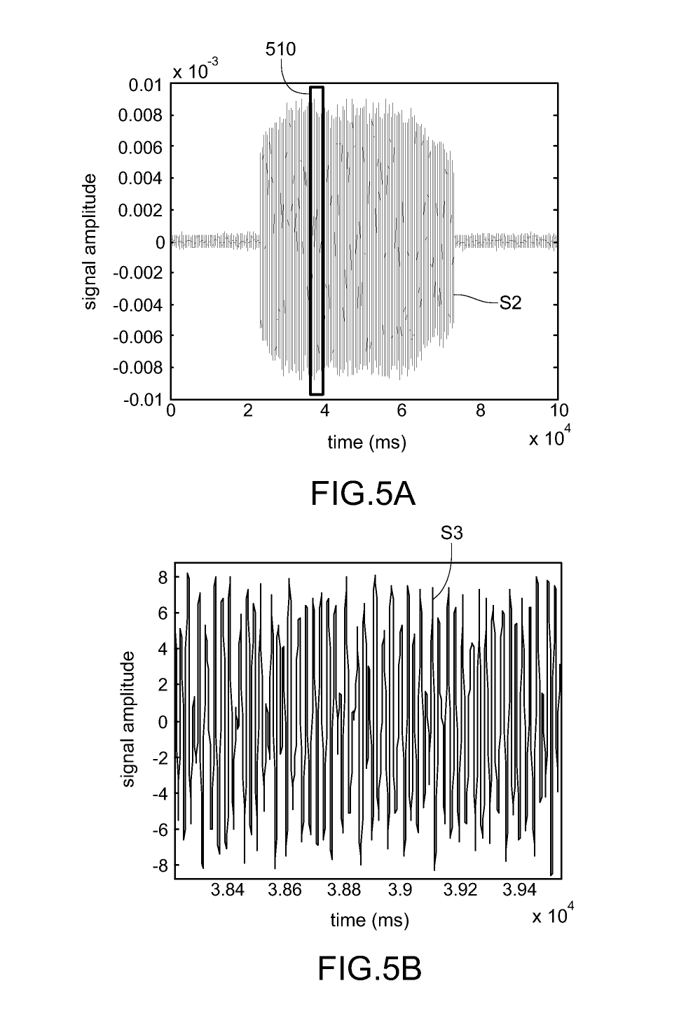

FIG. 5A is a schematic diagram of a signal waveform generated by a band pass filter receiving an optical signal generated by a first light emitting diode module according to the first embodiment of the disclosure. FIG. 5B is a schematic diagram of the signal waveform in FIG. 5A which is partially enlarged. In FIG. 5A and FIG. 5B, the horizontal axis is time (ms), and the vertical axis is the signal amplitude. The curve S2 corresponds to, for example, the waveform of the first message signal VN1, and the curve S3 is the amplified waveform of the curve S3 in the block region 510. According to FIG. 5A and FIG. 5B, the optical emitter 100 can efficiently transmit the data in the first message signal VM1 through the optical signals generated by the first LED module 130.

FIG. 6 and FIG. 7 are respectively a modulation signal constellation diagram and an eye diagram of the signals generated by a low pass filter receiving the signals of FIG. 5A. In FIG. 6, the horizontal axis represents the in-phase carrier wave I, and the vertical axis represents the orthogonal carrier wave Q. According to FIG. 6, the constellation of the modulation signals generated by low pass filtering the signals in FIG. 5A is spread. Thus, after the receiver receives the optical signals generated by the first LED module 130, the optical signals are easy to be demodulated, so as to recover the data of the first message signal VM1, which is carried in the optical signals generated by the optical emitter 100.

In FIG. 7, the sub-diagram 710 is the eye diagram corresponding to the in-phase carrier wave I, and the sub-diagram 720 is the eye diagram corresponding to the orthogonal carrier wave Q. The horizontal axes represents time (ms), and the vertical axes represents the amplitude. The bit error rate (BER) of the in-phase carrier wave I is, for example, 9.4×10⁻⁵, and the BER of the orthogonal carrier wave Q is, for example, 2.1×10⁻⁵. Therefore, in the transmission distance of 2 meters, the BER of the optical emitter 100 in this embodiment can be smaller than 10⁻⁴.

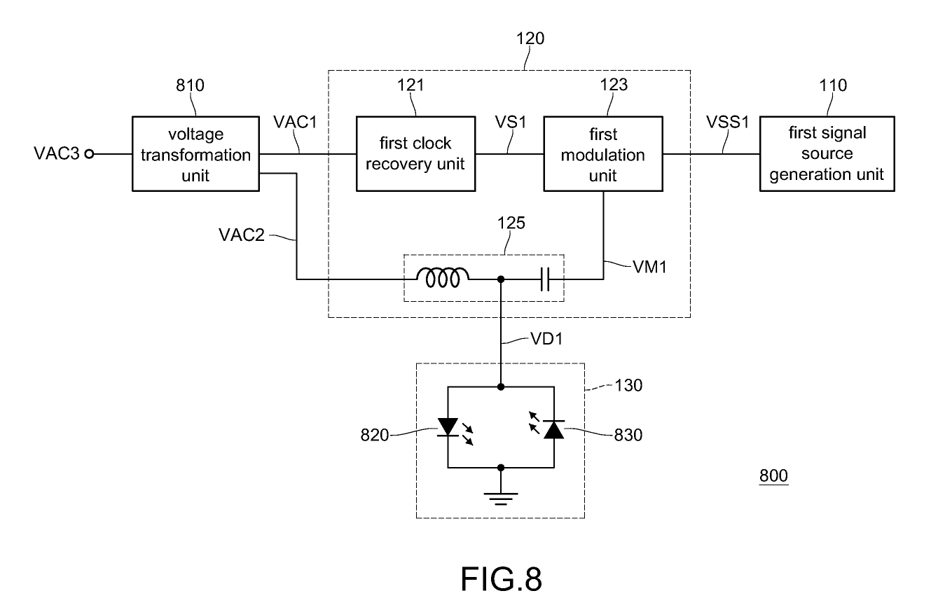

FIG. 8 is a schematic diagram of an optical emitter according to a second embodiment of the disclosure. The difference between the optical emitter 800 in this embodiment and the optical emitter 100 in FIG. 1 is that the optical emitter 800 in this embodiment further includes a voltage transformation unit 810.

The voltage transformation unit 810 is coupled to the first clock recovery unit 121 and a first bias tee unit 125. The voltage transformation unit 810 receives the third AC signal VAC3, such as the main power supply electricity of 110 V. In addition, the voltage transformation unit 810 transforms the voltage of the third AC signal VAC3. For example, the voltage transformation unit 810 lowers the voltage of the third AC signal VAC3 to generate the first AC signal VAC1 and the second AC signal VAC2. Moreover, the voltage levels and signal waveforms of the first AC signal VAC1 and the second AC signal VAC2 are the same.

In addition, the first LED module 130 includes two AC LEDs 820 and 830, and the AC LEDs 820 and 830 are coupled with each other in inverse parallel. The anode of the AC LED 820 receives the first driving signal VD1, and the cathode of the AC LED 820 is grounded, as shown in FIG. 8.

In this embodiment, the voltage transformation unit 810 generates the third AC signal VAC3 with lower voltage, so that the first LED module 130 does not receive the first driving signal VD1 with higher voltage. This may avoid the damaging of the first LED module 130 caused by high voltages. The rest of the components and the operation of the optical emitter 800 in this embodiment can refer to the descriptions of the embodiments in FIG. 1 to FIG. 7, thus are not repeatedly described herein. Moreover, the optical emitter 800 may have the same efficacies as the optical emitter 100.

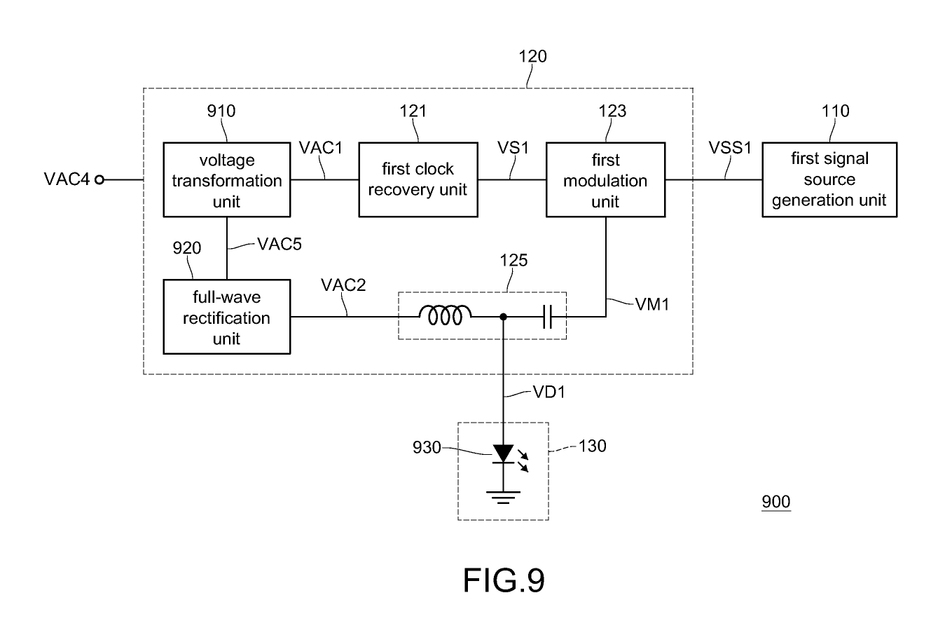

FIG. 9 is a schematic diagram of an optical emitter according to a third embodiment of the disclosure. The difference between the optical emitter 900 in this embodiment and the optical emitter 100 in FIG. 1 is that the optical emitter 900 in this embodiment further includes a voltage transformation unit 910.

The voltage transformation unit 910 receives a fourth AC signal VAC4, such as the main power supply electricity of 110 V. In addition, the voltage transformation unit 910 transforms the voltage of the fourth AC signal VAC4. For example, the voltage transformation unit 910 lowers the voltage of the fourth AC signal VAC4 to generate the first AC signal VAC1 and a fifth AC signal VAC5. The voltage level and signal waveform of the first AC signal VAC1 and of the fifth AC signal VAC5 are the same. The full-wave rectification unit 920 is coupled to the voltage transformation unit 910 and the first bias tee unit 125, receives the fifth AC signals VAC5, and rectifies the fifth AC signals VAC5. That is, the full-wave rectification unit 920 inverts all of the negative voltage waveforms of the fifth AC signals VAC5, and generates the second AC signals VAC2. All of the voltage waveforms of the second AC signals VAC2 are positive voltages.

Moreover, the first LED module 130 includes a direct-current (DC) LED 930. The anode of the DC LED 930 in the first LED module 130 receives the first driving signal VD1, and the cathode of the DC LED 930 in the first LED module 130 is grounded, as shown in FIG. 9.

The voltage transformation unit 910 generates the third AC signal VAC3 with lower voltages, so that the first LED module 130 does not receive the first driving signal VD1 with higher voltage. This may avoid the damaging of the first LED module 130 caused by the high voltages. The rest of the components and the operation of the optical emitter 900 in this embodiment can refer to the descriptions of the embodiments in FIG. 1 to FIG. 7, thus are not repeatedly described herein. In addition, the optical emitter 900 may have the same efficacies as the optical emitter 100.

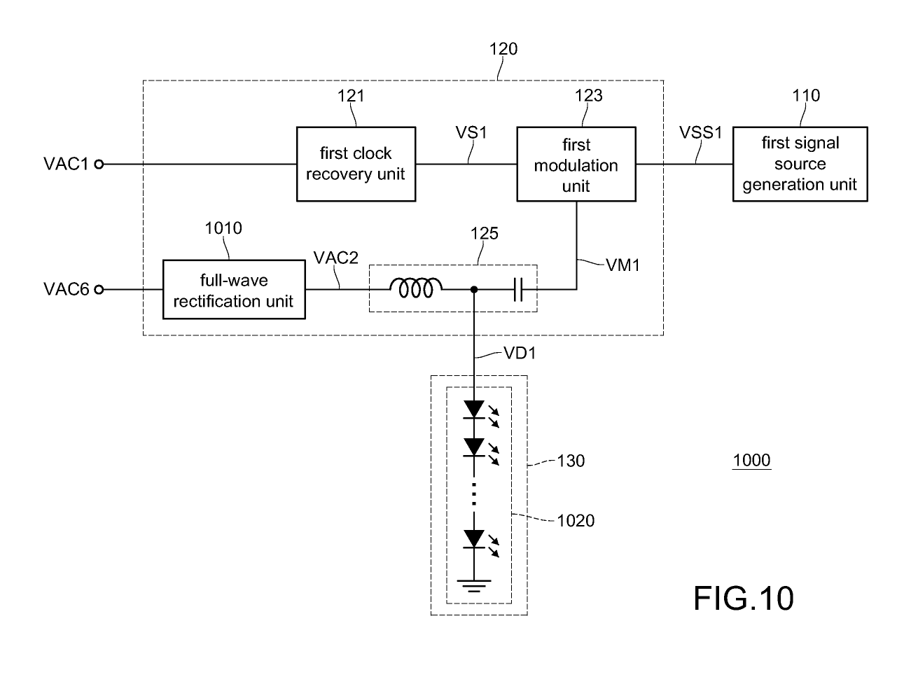

FIG. 10 is a schematic diagram of an optical emitter according to a fourth embodiment of the disclosure. The difference between the optical emitter 1000 in this embodiment and the optical emitter 100 in FIG. 1 is that the driving device 120 of the optical emitter 1000 in this embodiment further includes a full-wave rectification unit 1010.

The full-wave rectification unit 1010 is coupled to the first bias tee unit 125, receives a sixth AC signal VAC6, and rectifies the sixth AC signal VAC6. That is, the full-wave rectification unit 1010 inverts all of the negative voltage waveforms of the sixth AC signals VAC6 to generate the second AC signal VAC2. All of the voltage waveforms of the second AC signal VAC2 are positive voltages. The sixth AC signal VAC6 and the first AC signal VAC1 are, for example, the main power supply electricity of 110 V, and the voltage levels and the signal waveforms of the sixth AC signal VAC6 and the first AC signal VAC1 are the same.

In addition, the first LED module 130 includes a plurality of DC LEDs, which are coupled in series (hereinafter called “a DC LED series 1020”). The anode of the DC LED series 1020 of the first LED module 130 receive the first driving signal VD1, and the cathode of the DC LED series 1020 of the first LED module 130 are grounded, as shown in FIG. 10. The remaining components and relating operations of the optical emitter 1000 can refer to the descriptions of the embodiment in FIG. 1 to FIG. 7, thus are not repeatedly described herein. Moreover, the optical emitter 1000 may have the same efficacies as the optical emitter 100.

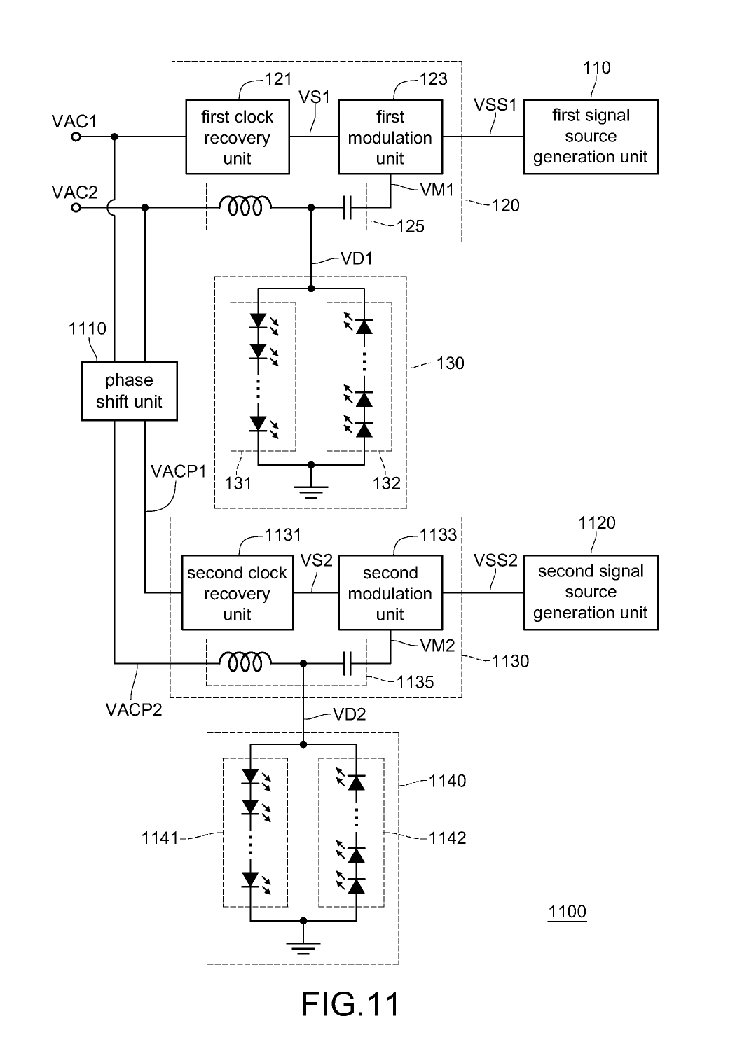

FIG. 11 is a schematic diagram of an optical emitter according to a fifth embodiment of the disclosure. The optical emitter 1100 in this embodiment includes the first signal source generation unit 110, the first LED module 130, a phase shift unit 1110, a second signal source generation unit 1120, a driving device 1130, and a second LED module 1140. The connections, components, and operations of the first signal source generation unit 110, the driving device 120, and the first LED module 130 can refer to the descriptions of the embodiment in FIG. 1, thus are not repeatedly described herein.

The phase shift unit 1110 receives the first AC signal VAC1 and the second AC signal VAC2, and shifts the first AC signal VAC1 and the second AC signal VAC2 to generate a first shifted AC signal VACP1 and a second shifted AC signal VACP2. The phase difference between the first shifted AC signal VACP1 and the first AC signals VAC1 is 90 degree, and the phase difference between the second shifted AC signal VACP2 and the second AC signal VAC2 is 90 degree. In addition, the voltage levels and the signal waveforms of the first shifted AC signal VACP1 and the second shifted AC signal VACP2 are the same.

The second signal source generation unit 1120 is for generating a second signal source VSS2. The implementations of the second signal source VSS2 can refer to the descriptions of the first signal source generation unit 110, thus are not described repeatedly. The driving device 1130 includes a second clock recovery unit 1131, a second modulation unit 1133, and a second bias tee unit 1135.

The second clock recovery unit 1131 receives the first shifted AC signal VACP1, and generates a second square wave signal VS2 according to the first shifted AC signal VACP1. The relating operations of the second clock recovery unit 1131 can refer to the descriptions of the first clock recovery unit 121, thus are not repeatedly described.

The second modulation unit 1133 is coupled to the second clock recovery unit 1131 and the second signal source generation unit 1120, for receiving the second square wave signal VS2 and the second signal source VSS2, and for generating a second message signal VM2 according to the second square wave signal VS2 and the second signal source VSS2. The relating operations of the second modulation unit 1133 can refer to the descriptions of the first modulation unit 123, thus are not repeatedly described.

The second bias tee unit 1135 is coupled to the second modulation unit 1133, for receiving the second shifted AC signal VACP2 and the second message signal VM2, and for generating a second driving signal VD2 according to the second shifted AC signal VACP2 and the second message signal VM2. The relating operations of the second bias tee unit 1135 can refer to the descriptions of the first bias tee unit 125, thus are not repeatedly described.

The second LED module 1140 is coupled to the second bias tee unit 1135, for receiving the second driving signal VD2, to generate a second optical signal. In addition, the second LED module 1140 includes a plurality of first LEDs, for example, AC LEDs, which are coupled in series (hereinafter called “a first LED series 1141”), and a plurality of second LEDs, for example, AC LEDs, which are coupled in series (hereinafter called “a second LED series 1142”). The first LED series 1141 is coupled to the second LED series 1142 in inverse parallel. The arrangements and relating operations of the second LED module 1140 can refer to the descriptions of the first LED module 130, thus are not repeatedly described herein.

In addition, the LED has the turned-on threshold. When the second driving signal VD2 is provided to the second LED module 1140, the voltage of the second driving signal VD2 is required to exceed the turned-on threshold of the LEDs in the second LED module 1140. The second LED module is turned on and emits light. Therefore, the second driving signal VD2 is clipped, and the second LED module 1140 is driven by the clipped second driving signal VD2′ to generate the optical signals. The period of the clipped second driving signal VD2′ is, for example, a time slot.

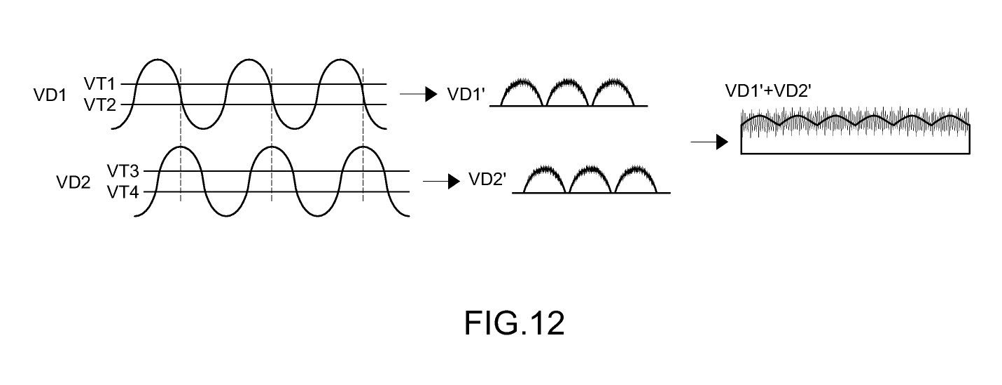

FIG. 12 is a schematic diagram of the first driving signal VD1, the clipped first driving signal VD1′, the second driving signal VD2, the clipped second driving signal VD2′, and a combination of the clipped first driving signal VD1′ and the clipped second driving signal VD2′, according to the fifth embodiment of the disclosure. The label VT1 represents the turned-on threshold of the first LED series 131, the label VT2 represents the turned-on threshold of the second LED series 132, the label VT3 represents the turned-on threshold of the first LED series 1141, the label VT4 represents the turned-on threshold of the second LED series 1142, and the labels T1, T2, T5, and T6 are time slots.

In FIG. 12, the first LED series 131 and the second LED series 132 correspond to the time slots Ti and T2, and the first LED series 1141 and the second LED series 1142 correspond to the time slots T5 and T6. In addition, the first message signal VM1 in the first driving signal VD1 is required to be provided in the time period of the time slots T1 and T2, and the second message signal VM2 in the second driving signal VD2 is required to be provided within the time period of the time slots T5 and T6. The optical signals generated by the first LED module 130 and the optical signals generated by the second LED module 1140 can transmit data efficiently. Specifically, the first LED module 130 and the second LED module 1140 are required to operate in a burst mode.

According to FIG. 12, the time slots T1 and T2 are respectively overlapping with the time slots T5 and T6. This causes that the optical emitter 100 generates the optical signal through the first LED module 130 and the second LED module 1140 alternately, so as to transmit data. This may increase the usage efficiency of the time slots to about 99%. That is, the phase shift unit 1110 generates the first driving signals VD1 and the second driving signals VD2 with different phases, so as to increase the usage efficiency of the time slots.

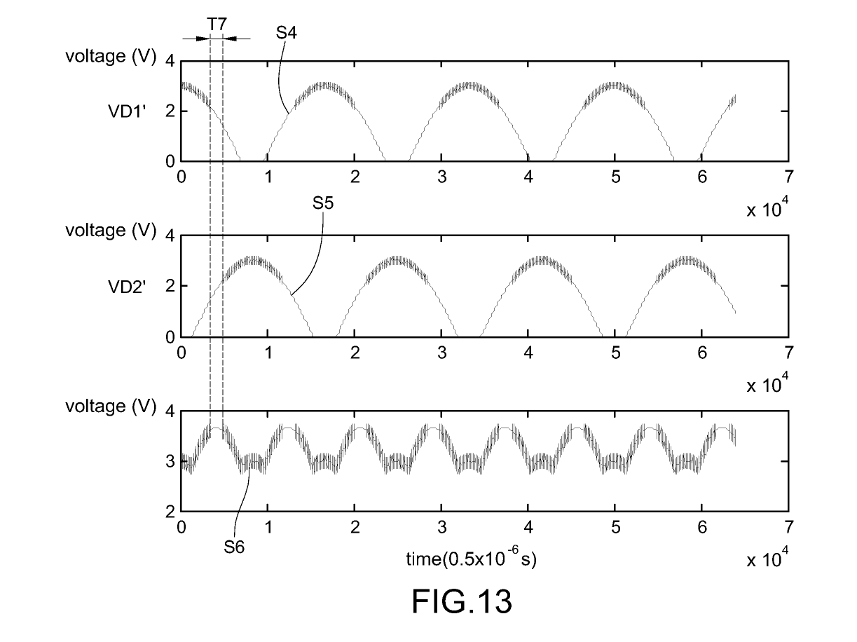

FIG. 13 is a simulation schematic diagram of the clipped first driving signal VD1′, the clipped second driving signal VD2′, and the combination of the clipped first driving signal VD1′ and the clipped second driving signal VD2′, which are measured by experiments, according to the fifth embodiment of the disclosure.

In FIG. 13, the curve S4 represents the waveform of the clipped first driving signal VD1′, the curve S5 represents the waveform of the clipped second driving signal VD2′, the curve S6 represents the waveform of the combination of the clipped first driving signals VD1′ and the clipped second driving signal VD2′, which are received by the oscilloscope. The time T7 is a guard time between the data carried by the clipped first driving signal VD1′ and the clipped second driving signal VD2′.

According to FIG. 13, the first LED module 130 and the second LED module 1140 operate alternately to generate the first optical signal and the second optical signal, and the first message signal VM1 carried by the first optical signal, and the second message signal VM2 carried by the second optical signal, can be transmitted in the time periods of the corresponding time slots. In addition, the guard time T7 is lower than about 10⁻⁶ seconds, which can efficiently increase the usage efficiency of the time slots.

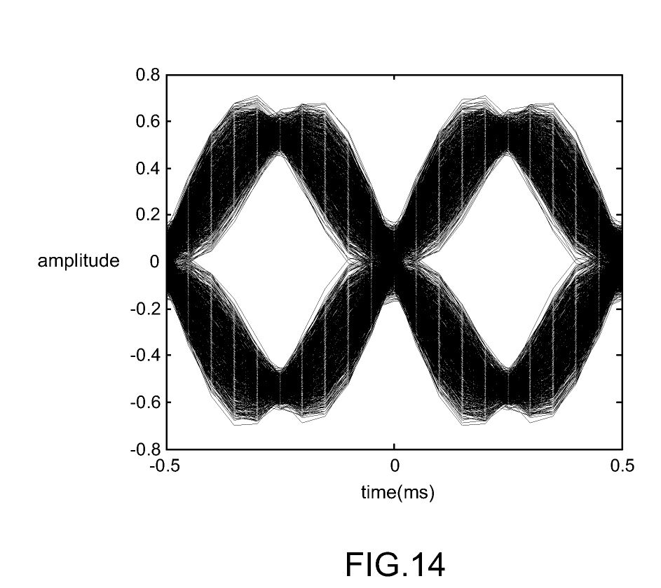

FIG. 14 is an eye diagram of signals generated by decoding a first optical signal and a second optical signal generated respectively by the first light emitting diode module and the second light emitting diode module in FIG. 11. The horizontal axis is time (ms), and the vertical axis represents the amplitude. According to FIG. 14, the optical emitter 1100 of this embodiment can have the BER lower than 10⁻³.

The driving devices 120 and 1130, the first LED module 130, and the second LED module 1140 in the optical emitter 1100 in this embodiment can refer to, for example, the structures of the driving device 120 and the first LED module 130 in the optical emitter 100 in FIG. 1. The driving devices 120 and 1130, the first LED module 130, and the second LED module 1140 of the optical emitter 1100 can also refer to the structures of the driving devices 120 and the first LED modules 130 of the optical emitters 800, 900, and 1000 in FIG. 8 to FIG. 10, and may still achieve the same efficacies.

In addition, the optical emitter 1100 of the aforementioned embodiment generates the first shifted AC signal VACP1 and the second shifted AC signal VACP2 via the phase shift unit 1110. A phase difference between the first shifted AC signal VACP1 and the first AC signal VAC1 is 90 degree, and a phase difference between the second shifted AC signal VACP2 and the second AC signal VAC2 is 90 degree. Therefore, the driving devices 120 and 1130 respectively generate the first driving signal VD1 and the second driving signal VD2, in order to drive the first LED module 130 and the second LED module 1140 to generate the optical signals. This may efficiently increase the usage efficiencies of the time slots. However, the disclosure is not limited thereby, and the optical emitter can also use more than two sets of driving devices for driving the corresponding numbers of LED modules. The following descriptions show another example.

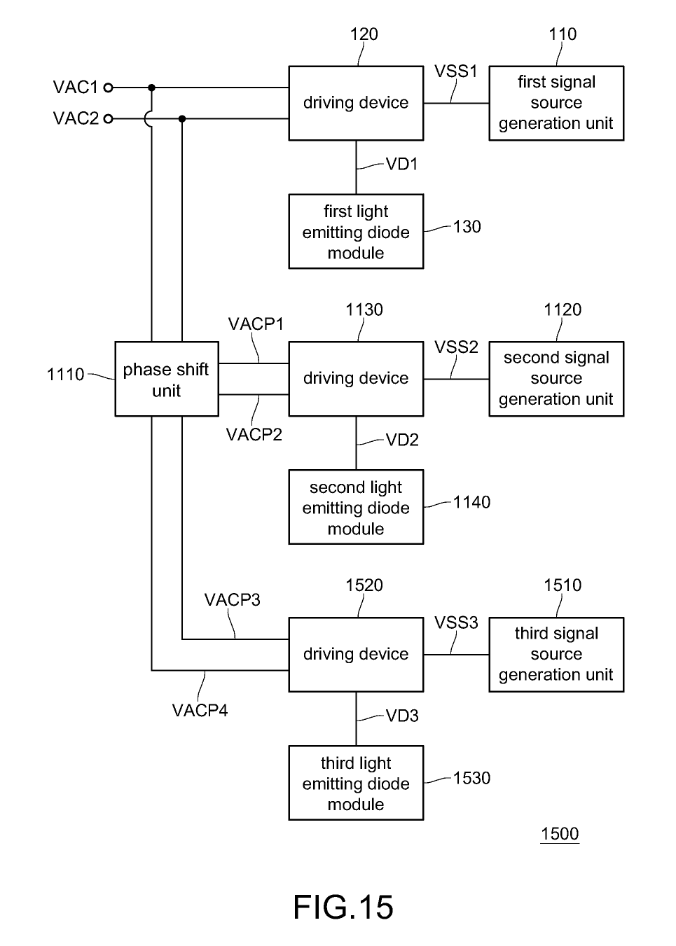

FIG. 15 is a schematic diagram of the optical emitter according to the sixth embodiment of the disclosure. The optical emitter 1500 in this embodiment includes the first signal source generation unit 110, the driving device 120, the first LED module 130, the phase shift unit 1110, the second signal source generation unit 1120, the driving device 1130, the second LED module 1140, a third signal source generation unit 1510, a driving device 1520, and a third LED module 1530.

The coupling relations, internal components, and the operations of the first signal source generation unit 110, the driving device 120, the first LED module 130, the second signal source generation unit 1120, the driving device 1130 and the second LED module 1140 can refer to the descriptions of the embodiment in FIG. 11, thus are not repeatedly described.

The phase shift unit 1110 receives the first AC signals VAC1 and the second AC signals VAC2, and shifts the first AC signal VAC1 and the second AC signal VAC2. Besides generating the first shifted AC signal VACP1 and the second shifted AC signal VACP2, the phase shift unit 1110 also generates a third shifted AC signal VACP3 and a fourth shifted AC signal VACP4.

The first shifted AC signal VACP1 and the first AC signal VAC1 have a phase difference of 60 degree therebetween. The second shifted AC signal VACP2 and the second AC signal VAC2 have a phase difference of 60 degree therebetween. The third shifted AC signal VACP3 and the first AC signals VAC1 have a phase difference of 120 degree therebetween. The fourth shifted AC signal VACP4 and the second AC signal VAC2 have a phase difference of 120 degree. The third shifted AC signal VACP3 and the first shifted AC signals VACP1 have a phase difference of 60 degree therebetween. The fourth shifted AC signal VACP4 and the second shifted AC signals VACP2 also have a phase difference of 60 degree. The voltage levels and the signal waveforms of the first shifted AC signal VACP1 and the second shifted AC signal VACP2 are the same, and the voltage levels and the signal waveforms of the third shifted AC signal VACP3 and the fourth shifted AC signal VACP4 are the same.

The third signal source generation unit 1510 is for generating a third signal source VSS3. The implementation manner of the third signal source generation unit 1510 can refer to the description of the first signal source generation unit 110, thus are not repeatedly described herein. The driving device 1520 is for generating a third driving signal VD3 according to the third shifted AC signal VACP3, the fourth shifted AC signal VACP4, and the third signal source VSS3. The internal components, coupling relations, and operations of the driving device 1520 can refer to the description of the driving device 120, thus are not repeatedly described.

The third LED module 1530 is for generating a third optical signal according to the third driving signal VD3, and the implementation manner of the third LED module 1530 can refer to the description of the first LED module 130, thus are not repeatedly described herein. Therefore, the optical emitter 1500 in this embodiment may increase the usage efficiencies of the time slots.

According to the embodiments of FIG. 11 and FIG. 15, the first AC signal VAC1 and the shifted AC signal generated by the phase shift unit 1110, have a phase difference of 180/N degree therebetween, and the second AC signal VAC2 and the shifted AC signal have a phase difference of 180/N degree. The number of the shifted AC signals is, for example, (N−1)×2, wherein N is the number of the corresponding driving devices.

For example, when the number of the driving device is 2, such as the driving devices 120 and 1130 shown in FIG. 11, the phase difference is 90 degree (180/2=90), and the number of the shifted AC signals generated by the phase shift unit 1110 is 2 ((2−1)×2=2), such as the first shifted AC signals VACP1 and the second shifted AC signals VACP2. The first AC signal VAC1 and the first shifted AC signals VACP1 have a phase difference of 90 degree therebetween. The second AC signal VAC2 and the second shifted AC signal VACP2 have a phase difference of 90 degree therebetween.

When the number of the driving devices is 3, such as the driving devices 120, 1130, and 1520 shown in FIG. 15, the phase difference is 60 degree (180/3=60), and the number of the shifted AC signals generated by the phase shift unit 1110 is 4 ((3−1)×2=4), such as the first shifted AC signal VACP1, the second shifted AC signal VACP2, the third shifted AC signal VACP3, and the fourth shifted AC signal VACP4. The first AC signals VAC1 and the first shifted AC signal VACP1 have a phase difference of 60 degree therebetween. The second AC signal VAC2 and the second shifted AC signal VACP2 have a phase difference of 60 degree. The first shifted AC signal VACP1 and the third shifted AC signal VACP3 have a phase difference of 60 degree. The second shifted AC signal VACP2 and the fourth shifted AC signal VACP4 have a phase difference of 60 degree. The rest of the calculations are deduced by the similar manners. No matter what the number of the driving devices is, the usage efficiencies of the time slots may be increased as the optical emitters 1100 and 1500.

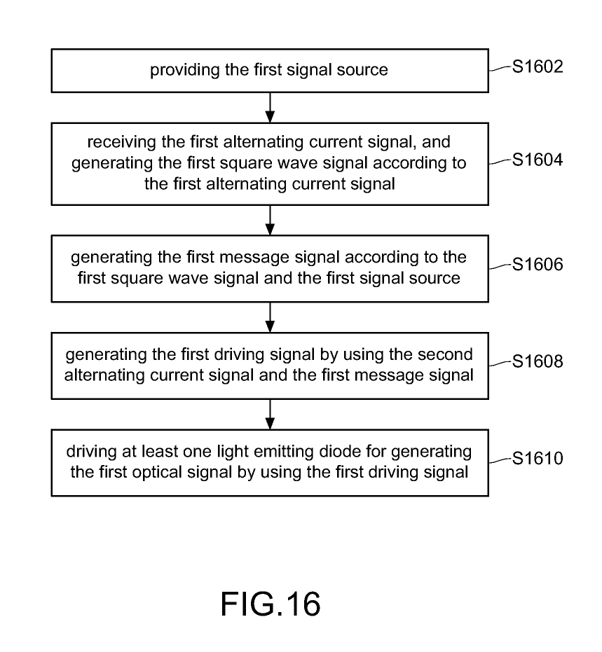

According to the descriptions of the aforementioned embodiments, an operation method of an optical emitter can be derived. FIG. 16 is a flow chart of an operation method of an optical emitter according to an embodiment of the disclosure. In step S1602, the first signal source is provided. In step S1604, the first AC signal is received, so as to generate the first square wave signal according to the first AC signal.

In step S1606, the first message signal is generated according to the first square wave signal and the first signal source. In step S1608, the first driving signal is generated by using the second AC signal and the first message signal. In step S1610, at least one first LED is driven by the first driving signal, for generating the first optical signal.

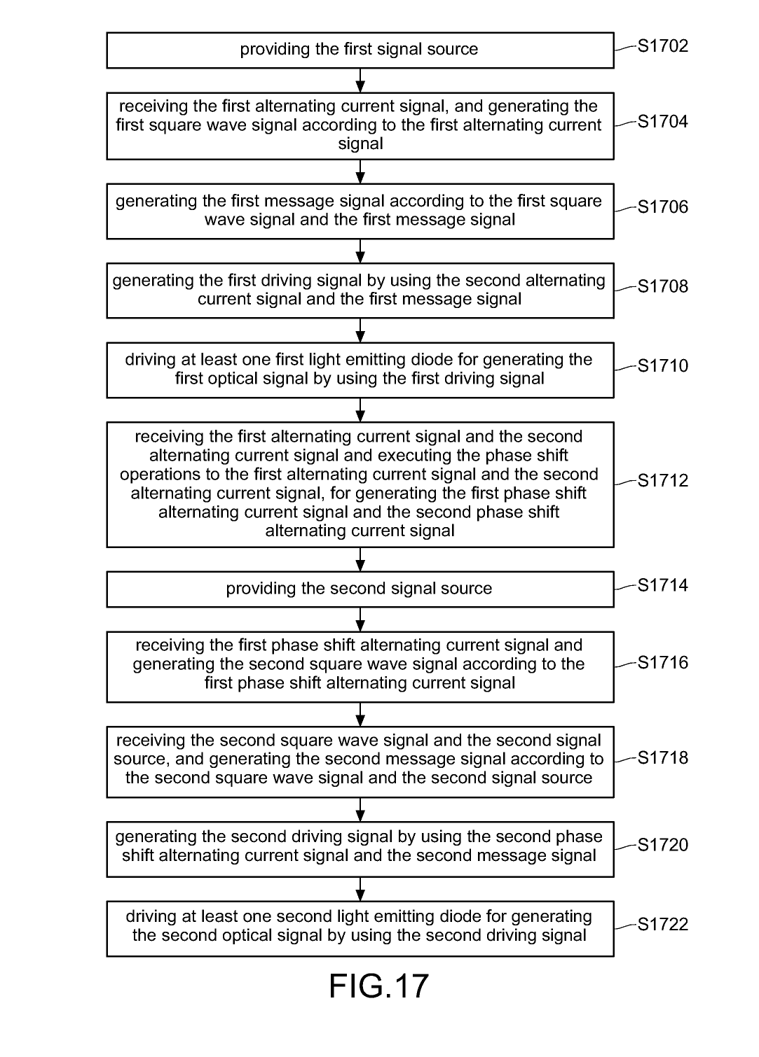

FIG. 17 is a flow chart of an operation method of an optical emitter according to another embodiment of the disclosure. In step S1702, the first signal source is provided. In step S1704, the first AC signal is received, and the first square wave signal is generated according to the first AC signal.

In step S1706, the first message signal is generated according to the first square wave signal and the first signal source. In step S1708, the first driving signal is generated by using the second AC signal and the first message signal. In step S1710, at least one first LED is driven by using the first driving signal for generating the first optical signal.

In step S1712, the first AC signal and the second AC signal are received and shifted to generate the first shifted AC signal and the second shifted AC signal. In step S1714, the second signal source is provided. In step S1716, the first shifted AC signal is received, and the second square wave signal is generated according to the first shifted AC signal.

In step S1718, the second square wave signal and the second signal source are received, and the second message signal is generated according to the second square wave signal and the second signal source. In step S1720, the second driving signal is generated by using the second shifted AC signal and the second message signal. In step S1722, at least one second LED is driven by the second driving signal, for generating the second optical signal.

In the disclosure, the clock recovery unit generates the square wave signal according to the first AC signal, the modulation unit generates the message signal according to the signal source, which is generated by the signal source generation unit, and the square wave signal, and the bias tee unit combines the second AC signal and the message signal to drive at least one LED to generate the optical signals. Therefore, the optical emitter (driving device) can operate without using an AC to DC converter, and may have low cost, high efficiency and no signal transmission distortion.

In addition, in the disclosure, the phase shift unit correspondingly generates shifted AC signals which have phases different from those of the first AC signal and the second AC signal, for driving the first LED module and the second LED module. This may increase the usage efficiencies of the time slots in which data transmission is performed, and further increase the signal transmission rate of the LED. Moreover, the optical emitters of the disclosure are suitable for driving the DC LED and the AC LED, to efficiently increase the usage conveniences of the visible light communications.

What is claimed is:

1. A driving device, adapted to drive at least one light emitting diode (LED), and comprising:
a clock recovery unit, for receiving a first alternating current (AC) signal, and generating a square wave signal according to the first alternating current signal;
a modulation unit, coupled to the clock recovery unit, for receiving the square wave signal and a signal source, and generating a message signal according to the square wave signal and the signal source; and
a bias tee unit, coupled to the modulation unit, for receiving a second alternating current signal and the message signal, and for outputting a driving signal to the at least one light emitting diode by using the second alternating current signal and the message signal, in order to make the at least one light emitting diode generate an optical signal.

2. The driving device according to claim 1, wherein the at least one light emitting diode includes two alternating current light emitting diodes coupled with each other in inverse parallel, and the driving device further comprises:
a voltage transformation unit, coupled to the clock recovery unit and the bias tee unit, for receiving a third alternating current signal and transforming a voltage of the third alternating current signal to generate the first alternating current signal and the second alternating current signal.

3. The driving device according to claim 1, wherein the at least one light emitting diode comprises a direct current light emitting diode, and the driving device further comprises:
a voltage transformation unit, coupled to the clock recovery unit, for receiving a fourth alternating current signal and transforming a voltage of the fourth alternating current signal to generate the first alternating current signal and a fifth alternating current signal; and
a full-wave rectification unit, coupled to the voltage transformation unit and the bias tee unit, for receiving the fifth alternating current signal and rectifying the fifth alternating current signal to generate the second alternating current signal.

4. The driving device according to claim 1, wherein the at least one light emitting diode comprises a plurality of direct current light emitting diodes which are coupled in series, and the driving device further comprises:
a full-wave rectification unit, coupled to the bias tee unit, for receiving a sixth alternating current signal and rectifying the sixth alternating current signal to generate the second alternating current signal.

5. An optical emitter, comprising:
a first signal source generation unit, for generating a first signal source;
a first clock recovery unit, for receiving a first alternating current signal, and generating a first square wave signal according to the first alternating current signal;
a first modulation unit, coupled to the first clock recovery unit, for receiving the first square wave signal and the first signal source, and for generating a first message signal according to the first square wave signal and the first signal source;
a first bias tee unit, coupled to the first modulation unit, for receiving a second alternating current signal and the first message signal, and for generating a first driving signal by using the second alternating current signal and the first message signal; and
at least one first light emitting diode, coupled to the first bias tee unit, for receiving the first driving signal, to generate a first optical signal.

6. The optical emitter according to claim 5, wherein the at least one first light emitting diode comprises a plurality of first alternating current light emitting diodes which are coupled in series, and a plurality of second alternating current light emitting diodes which are coupled in series, the series of the plurality of first alternating current light emitting diodes and the series of the plurality of second alternating current light emitting diodes are coupled in inverse parallel.

7. The optical emitter according to claim 5, wherein the at least one first light emitting diode comprises two alternating current light emitting diodes which are coupled in inverse parallel, and the optical emitter further comprises:
a voltage transformation unit, coupled to the first clock recovery unit and the first bias tee unit, for receiving a third alternating current signal and transforming a voltage of the third alternating current signal to generate the first alternating current signal and the second alternating current signal.

8. The optical emitter according to claim 5, wherein the at least one first light emitting diode comprises a direct current light emitting diode, and the optical emitter further comprises:
a voltage transformation unit, coupled to the first clock recovery unit, for receiving a fourth alternating current signal and transforming a voltage of the fourth alternating current signal to generate the first alternating current signal and a fifth alternating current signal; and
a full-wave rectification unit, coupled to the voltage transformation unit and the first bias tee unit, for receiving the fifth alternating current signal and rectifying the fifth alternating current signal to generate the second alternating current signal.

9. The optical emitter according to claim 5, wherein the at least one first light emitting diode comprises a plurality of direct current light emitting diodes which are coupled in series, and the optical emitter further comprises:
a full-wave rectification unit, coupled to the first bias tee unit, for receiving a sixth alternating current signal and rectifying the sixth alternating current signal to generate the second alternating current signal.

10. The optical emitter according to claim 5, further comprising:
a phase shift unit, for receiving the first alternating current signal and the second alternating current signal, and for shifting the first alternating current signal and the second alternating current signal to generate a first shifted alternating current signal and a second shifted alternating current signal;
a second signal source generation unit, for generating a second signal source;
a second clock recovery unit, for receiving the first shifted alternating current signal, and generating a second square wave signal according to the first shifted alternating current signal;
a second modulation unit, coupled to the second clock recovery unit and the second signal source generation unit, for receiving the second square wave signal and the second signal source, and for generating a second message signal according to the second square wave signal and the second signal source;
a second bias tee unit, coupled to the second modulation unit, for receiving the second shifted alternating current signal and the second message signal, and for generating a second driving signal by using the second shifted alternating current signal and the second message signal; and
at least one second light emitting diode, coupled to the second bias tee unit, for receiving a second optical signal generated by the second driving signal.

11. The optical emitter according to claim 10, wherein the at least one second light emitting diode comprises a plurality of first alternating current light emitting diodes which are coupled in series, and a plurality of second alternating current light emitting diodes which are coupled in series, the series of the plurality of first alternating current light emitting diodes and the series of the plurality of second alternating current light emitting diodes are coupled in inverse parallel.

12. The optical emitter according to claim 10, wherein the at least one second light emitting diode comprises two alternating current light emitting diodes which are coupled in inverse parallel, and the optical emitter further comprises:
a voltage transformation unit, coupled to the second clock recovery unit and the second bias tee unit, for receiving a third alternating current signal and transforming a voltage of the third alternating current signal to generate the first alternating current signal and the second alternating current signal.

13. The optical emitter according to claim 10, wherein the at least one second light emitting diode comprises a direct current light emitting diode, and the optical emitter further comprises:
a voltage transformation unit, coupled to the second clock recovery unit, for receiving a fourth alternating current signal and transforming a voltage of the fourth alternating current signal to generate the first alternating current signal and a fifth alternating current signal; and
a full-wave rectification unit, coupled to the voltage transformation unit and the second bias tee unit, for receiving the fifth alternating current signal and rectifying the fifth alternating current signal to generate the second alternating current signal.

14. The optical emitter according to claim 10, wherein the at least one second light emitting diode comprises a plurality of direct current light emitting diodes which are coupled in series, and the optical emitter further comprises:
a full-wave rectification unit, coupled to the second bias tee unit, for receiving a sixth alternating current signal, and for rectifying the sixth alternating current signal to generate the second alternating current signal.

15. An operation method of an optical emitter, comprising:
providing a first signal source;
receiving a first alternating current signal, and generating a first square wave signal according to the first alternating current signal;
generating a first message signal according to the first square wave signal and the first signal source;
generating a first driving signal by using a second alternating current signal and the first message signal; and
driving at least one first light emitting diode by using the first driving signal to generate a first optical signal.

16. The operation method of the optical emitter according to claim 15, further comprising:
receiving the first alternating current signal and the second alternating current signal, and shifting the first alternating current signal and the second alternating current signal to generating a first shifted alternating current signal and a second shifted alternating current signal;
providing a second signal source;
receiving the first shifted alternating current signal, and generating a second square wave signal according to the first shifted alternating current signal;
receiving the second square wave signal and the second signal source, and generating a second message signal according to the second square wave signal and the second signal source;
generating a second driving signal by using the second shifted alternating current signal and the second message signal; and
driving at least one second light emitting diode by using the second driving signal to generate a second optical signal.
